(19) United States
(12) Patent Application Publication
(10) Pub. No.: US 2021/0227437 A1
(43) Pub. Date: Jul. 22, 2021

(54) Efficient Emergency Services Fallback

(71) Applicant: Apple Inc., Cupertino, CA (US)

(72) Inventors: Vijay Venkataraman, San Jose, CA (US); Srinivasan Nimmala, San Jose, CA (US); Longda Xing, San Jose, CA (US); Kavya B. Ravikumar, San Diego, CA (US); Krisztian Kiss, Hayward, CA (US); Yifan Zhu, San Jose, CA (US); Murtaza A. Shikari, Mountain View, CA (US); Robert K Kitchens, Cupertino, CA (US); Haijing Hu, Beijing (CN); Robert Zaus, Munich (DE)

(21) Appl. No.: 17/154,582

(22) Filed: Jan. 21, 2021

Related U.S. Application Data
(60) Provisional application No. 62/964,512, filed on Jan. 22, 2020.

(51) Int. Cl. H04W 36/14; H04W 4/90; H04W 48/02; H04W 60/04

(52) U.S. Cl. CPC H04W 36/14; H04W 60/04; H04W 48/02; H04W 4/90

(57) ABSTRACT

Apparatuses, systems, and methods for performing efficient emergency services fallback. A cellular network element may provide emergency services fallback information to a wireless device during 3GPP 5GS cellular registration. The emergency services fallback information may include an indication of whether emergency services fallback via fallback to evolved packet core service is supported. The emergency services fallback information may also include an indication of whether emergency services fallback via fallback to circuit switched service is supported.

### PRIORITY INFORMATION

This application claims priority to U.S. provisional patent application Ser. No. 62/964,512, entitled “Efficient Emergency Services Fallback,” filed Jan. 22, 2020, which is hereby incorporated by reference in its entirety as though fully and completely set forth herein.

### FIELD

The present application relates to wireless devices, and more particularly to apparatus, systems, and methods for performing efficient emergency services fallback in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including fifth generation (5G) new radio (NR) communication. Accordingly, improvements in the field in support of such development and design are desired.

### SUMMARY

Embodiments relate to apparatuses, systems, and methods for performing efficient emergency services fallback in a wireless communication system.

According to the techniques described herein, a cellular network may provide information regarding emergency services fallback support provided by the network to wireless devices. Such information may include an indication of whether a fifth generation cell supports emergency services fallback via fallback to evolved packet core service and/or via circuit switched service. Such information may assist the wireless devices to determine how to attempt to obtain emergency services when a user initiates an attempt to obtain emergency services. In particular, a wireless device may be able to avoid attempting to obtain emergency services via unsupported mechanisms and instead more quickly attempt to obtain emergency services via a supported mechanism, which may in turn reduce the amount of time between initiating the attempt to obtain emergency services and actually obtaining access to emergency services.

Techniques are also described herein for a wireless device to store and report information regarding the outcome of any attempts to obtain emergency services by way of any cells used by the wireless device to attempt to obtain emergency services. Such information may be reported to a centralized server that aggregates such reported information across multiple users to determine emergency services performance information for one or more sets of cells. The emergency services performance information (and/or information determined based at least in part on such information) may in turn be provided to wireless devices, e.g., as emergency services fallback support information that can be used by the wireless devices when determining how to attempt to obtain emergency services.

The techniques described herein may be implemented in and/or used with a number of different types of devices, including but not limited to cellular phones, tablet computers, wearable computing devices, portable media players, unmanned aerial vehicles, unmanned aerial controllers, automobiles and/or motorized vehicles, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a UE, according to some embodiments;

FIG. 4 illustrates an example block diagram of a BS, according to some embodiments;

FIG. 5 illustrates an example block diagram of cellular communication circuitry, according to some embodiments;

FIG. 6 illustrates an example block diagram of a network element, according to some embodiments;

FIG. 7 is a flowchart diagram illustrating an example method for performing efficient emergency services fallback in a wireless communication system; according to some embodiments;

FIG. 8 is a table illustrating possible fields of a 5GS network feature support information element that could be provided to a wireless device during registration with a cellular network, according to some embodiments;

FIGS. 9-13 are communication flow diagrams illustrating possible emergency services fallback signaling that could be used in various scenarios, according to some embodiments; and

FIG. 14 is a communication flow diagram illustrating possible differences between accessing emergency services via fallback to circuit switched service with and without provision of emergency services fallback support information, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™ PlayStation Portable™, Gameboy Advance™, iPhone™), laptops, wearable devices (e.g. smart watch, smart glasses), PDAs, portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

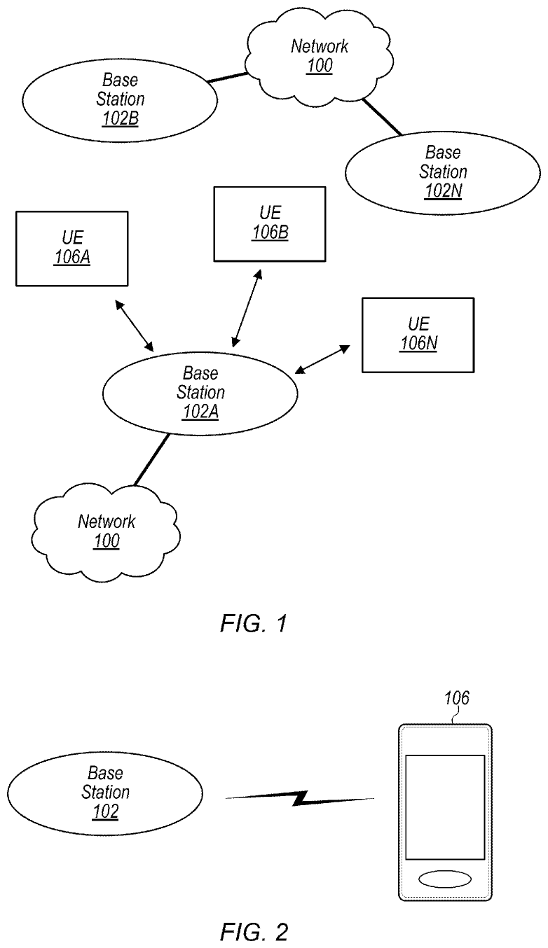

### FIGS. 1 and 2—Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that the base station 102A and one or more other base stations 102 support joint transmission, such that UE 106 may be able to receive transmissions from multiple base stations (and/or multiple TRPs provided by the same base station).

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer, a laptop, a tablet, a smart watch or other wearable device, an unmanned aerial vehicle (UAV), an unmanned aerial controller (UAC), an automobile, or virtually any type of wireless device.

The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

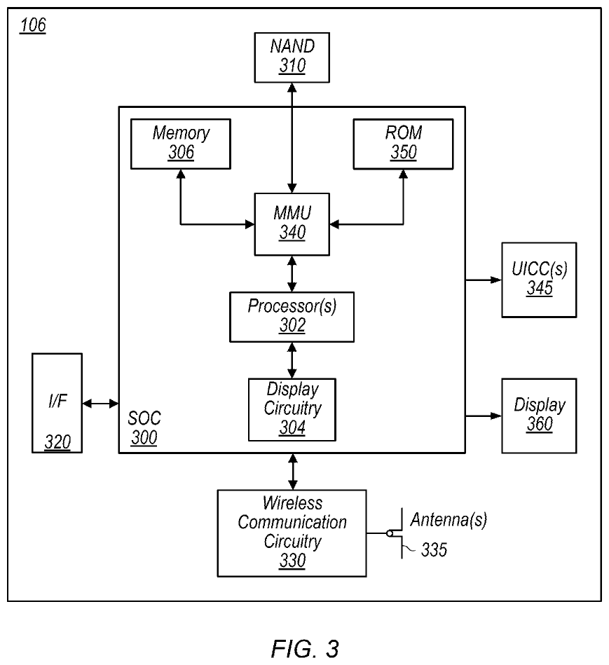

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, etc.). In some embodiments, communication device 106 may include wired communication circuitry (not shown), such as a network interface card, e.g., for Ethernet.

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, etc.) configured to perform the functions of wireless communication circuitry 330.

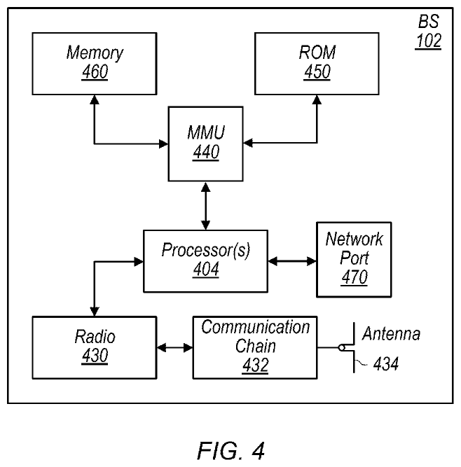

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

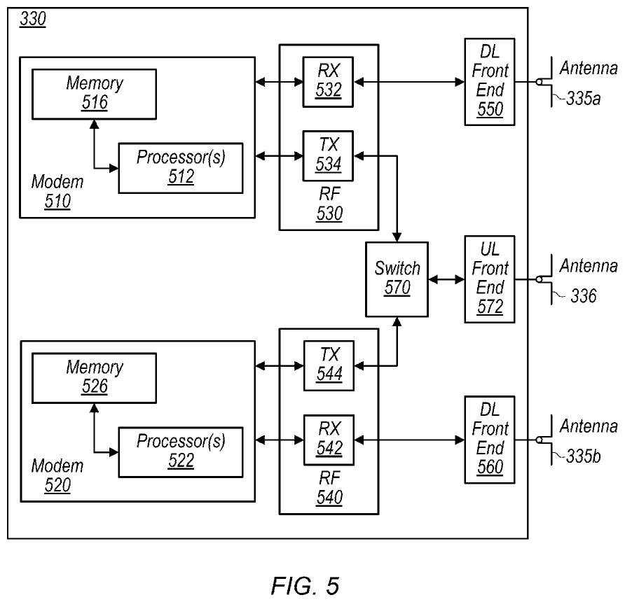

### FIG. 5—Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some embodiments, the cellular communication circuitry 330 may also not include the switch 570, and the RF front end 530 or the RF front end 540 may be in communication, e.g., directly, with the UL front end 572.

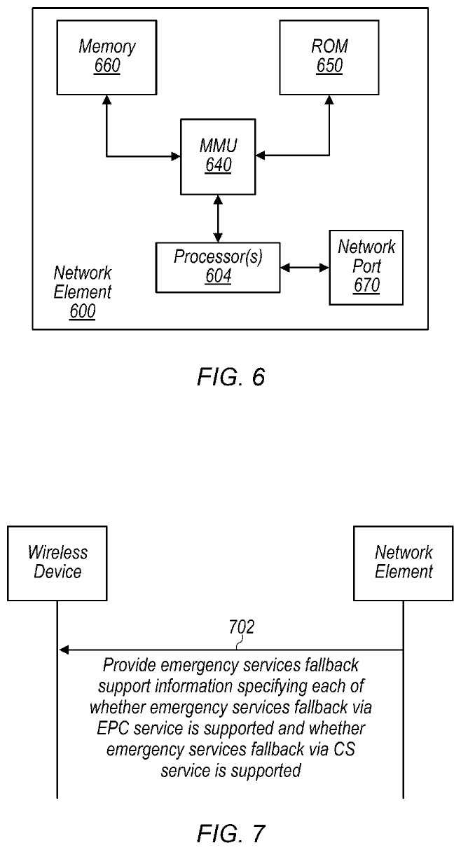

### FIG. 6—Exemplary Block Diagram of a Network Element

FIG. 6 illustrates an exemplary block diagram of a network element 600, according to some embodiments. According to some embodiments, the network element 600 may implement one or more logical functions/entities of a cellular core network, such as a mobility management entity (MME), serving gateway (S-GW), access and management function (AMF), session management function (SMF), etc. It is noted that the network element 600 of FIG. 6 is merely one example of a possible network element 600. As shown, the core network element 600 may include processor(s) 604 which may execute program instructions for the core network element 600. The processor(s) 604 may also be coupled to memory management unit (MMU) 640, which may be configured to receive addresses from the processor(s) 604 and translate those addresses to locations in memory (e.g., memory 660 and read only memory (ROM) 650) or to other circuits or devices.

The network element 600 may include at least one network port 670. The network port 670 may be configured to couple to one or more base stations and/or other cellular network entities and/or devices. The network element 600 may communicate with base stations (e.g., eNBs/gNBs) and/or other network entities/devices by means of any of various communication protocols and/or interfaces.

As described further subsequently herein, the network element 600 may include hardware and software components for implementing and/or supporting implementation of features described herein. The processor(s) 604 of the core network element 600 may be configured to implement or support implementation of part or all of the methods described herein, e.g., by executing program instructions stored on a memory medium (e.g., a non-transitory computer-readable memory medium). Alternatively, the processor 604 may be configured as a programmable hardware element, such as an FPGA (Field Programmable Gate Array), or as an ASIC (Application Specific Integrated Circuit), or a combination thereof.

### FIG. 7—Efficient Emergency Services Fallback

New cellular communication techniques are continually under development, to increase coverage, to better serve the range of demands and use cases, and for a variety of other reasons. As new cellular communication technologies is developed and deployed, certain features may be included that are new or differ from previously developed and deployed cellular communication technologies.

As the number of generations of cellular communication technologies that can be deployed simultaneously (e.g., in parallel) increases, so may the potential number of options for a wireless device to obtain emergency services. In various scenarios, it may be the case that different options are available for obtaining emergency services. For example, some cellular service providers may provide emergency services via one or more cellular communication technologies but not via one or more other cellular communication technologies.

In order to ensure that wireless devices are able to efficiently obtain emergency services, it may accordingly be useful to provide a framework for cellular service providers to specify which mechanisms for obtaining emergency services are available to wireless devices that obtain cellular service from them. This may, for example, reduce the likelihood that a wireless device attempts to obtain emergency services from a cellular service provider via a mechanism that is not supported by that cellular service provider, which may in turn reduce any potential delay to the user being connected to emergency services.

Accordingly, FIG. 7 is a signal flow diagram illustrating an example of a method for performing efficient emergency services fallback in a wireless communication system, at least according to some embodiments. Aspects of the method of FIG. 7 may be implemented by a wireless device such as a UE 106 illustrated in various of the Figures herein, a base station such as a BS 102 illustrated in various of the Figures herein, a network element such as an AMF, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method of FIG. 7 may operate as follows.

In 702, a cellular network element may provide emergency services fallback support information to a wireless device during third generation partnership project (3GPP) fifth generation system (5GS) cellular registration. The emergency services fallback support information may include an indication of whether emergency services fallback via fallback to E-UTRA and/or evolved packet core (EPC) service is supported. The emergency services fallback support information may also include an indication of whether emergency services fallback via fallback to circuit switched (CS) service is supported. As another possibility, the emergency services fallback support information may include a (e.g., 1 bit) indication of whether no information is provided regarding emergency services fallback support or emergency services fallback support includes fallback to EPS service followed by fallback to CS service. Any of various other types of information and/or formats may also or alternatively be included in and/or used for the emergency services fallback support information, in various instances.

According to some embodiments, the emergency services fallback support information may be provided in a 5GS network features support information element. For example, the indication of whether emergency services fallback via fallback to EPC service is supported may be included in a first field of the 5GS network features support information element, while the indication of whether emergency services fallback via fallback to CS service is supported may be included in a second (e.g., different) field of the 5GS network features support information element. Alternatively, the indication of whether emergency services fallback via fallback to EPC service is supported and the indication of whether emergency services fallback via fallback to CS service is supported may be provided in the same field, or according to any of various other possible manners.

The indication of whether emergency services fallback via fallback to EPC service is supported may include any or all of a variety of possible information. As one possibility, the indication may specify that one of: emergency services fallback via fallback to EPC service is not supported; emergency services fallback via fallback to EPC service is supported while connected to 5GS via a new radio (NR) air interface but not while connected to 5GS via an evolved universal terrestrial radio access (E-UTRA) air interface; emergency services fallback via fallback to EPC service is supported while connected to 5GS via an E-UTRA air interface but not while connected to 5GS via a NR air interface; or emergency services fallback via fallback to EPC service is supported while connected to 5GS via a NR air interface or an E-UTRA air interface.

Similarly, the indication of whether emergency services fallback via fallback to CS service is supported may include any or all of a variety of possible information. As one possibility, the indication may specify that one of: emergency services fallback via fallback to CS service is not supported; emergency services fallback via fallback to CS service is supported while connected to 5GS via a NR air interface but not while connected to 5GS via an E-UTRA air interface; emergency services fallback via fallback to CS service is supported while connected to 5GS via an E-UTRA air interface but not while connected to 5GS via a NR air interface; or emergency services fallback via fallback to CS service is supported while connected to 5GS via a NR air interface or an E-UTRA air interface.

In some instances, the cellular network element may further provide an indication of whether the emergency services fallback support information includes an indication of whether emergency services fallback via fallback to EPC service is supported and an indication of whether emergency services fallback via fallback to CS service is supported. For example, it may be the case that one or more previous 3GPP specification releases or versions do not include support for such specific indications of whether emergency services fallback via fallback to EPC service is supported and whether emergency services fallback via fallback to CS service is supported. In order to preserve backward compatibility with wireless devices and/or cellular network infrastructure equipment configured accordingly, it may thus be useful to provide an indication of whether the cellular network element supports the use of such specific indications of whether emergency services fallback via fallback to EPC service is supported and whether emergency services fallback via fallback to CS service is supported. At least in some instances, if the cellular network element indicates that specific indications of whether emergency services fallback via fallback to EPC service is supported and whether emergency services fallback via fallback to CS service is supported are not included in the emergency services fallback support information, the cellular network element may provide an alternate indication of what (if any) support for emergency services fallback is provided by the cellular network. For example, such an indication could specify that one of: emergency services fallback is not supported; emergency services fallback is supported while connected to 5GS via a NR air interface but not while connected to 5GS via an E-UTRA air interface; emergency services fallback is supported while connected to 5GS via an E-UTRA air interface but not while connected to 5GS via a NR air interface; or emergency services fallback is supported while connected to 5GS via a NR air interface or an E-UTRA air interface, without specifying via which RAT(s) emergency services fallback is supported (if at all).

Note that the cellular network element may also provide emergency services support information that indicates whether emergency services access via 5GS service is supported by the cellular network for the wireless device. Such an indication may include any or all of a variety of possible information. As one possibility, the indication may specify that one of: emergency services via 5GS service is not supported; emergency services via 5GS service is supported while connected to 5GS via a NR air interface but not while connected to 5GS via an E-UTRA air interface; emergency services via 5GS service is supported while connected to 5GS via an E-UTRA air interface but not while connected to 5GS via a NR air interface; or emergency services via 5GS service is supported while connected to 5GS via a NR air interface or an E-UTRA air interface.

The wireless device may determine how to attempt to obtain emergency services based at least in part on the emergency services support information and/or emergency services fallback support information provided by the cellular network element. For example, while the wireless device is connected with (e.g., has a radio resource control (RRC) connection, or possibly is camped on in idle mode) a cell (e.g., a cell provided by the cellular network associated with the cellular network element with which the wireless device performed registration for 5GS cellular service), the wireless device may receive user input initiating an attempt to obtain emergency services, or may otherwise determine that a trigger to attempt to obtain emergency services has occurred, and so may determine how to attempt to obtain emergency services based at least in part on the emergency services support information and/or emergency services fallback support information provided by the cellular network element. The trigger could include an outgoing call by a user of the wireless device to a telephone number designated as an emergency telephone number (e.g., a 911 call in North America, as one possibility), a text message to an emergency services number, or another possible trigger.

For example, as one possibility, if the emergency services support information indicates that emergency services via 5GS service is not supported via the air interface(s) available to the wireless device (or possibly if it is supported but an attempt to obtain emergency services via 5GS service is unsuccessful), and the emergency services fallback support information indicates that emergency services fallback via fallback to EPC service is supported and emergency services fallback via fallback to CS service is not supported, the wireless device may perform fallback to EPC service to attempt to obtain emergency services based at least in part on the emergency services fallback support information. Further, if the attempt to obtain emergency services via fallback to EPC service is unsuccessful, the wireless device may next proceed to search for a different public land mobile network (PLMN) based at least in part on the emergency services fallback support information, e.g., instead of next attempting to obtain emergency services via fallback to CS service with the same PLMN.

As another possibility, if the emergency services support information indicates that emergency services via 5GS service is not supported via the air interface(s) available to the wireless device (or possibly if it is supported but an attempt to obtain emergency services via 5GS service is unsuccessful), and the emergency services fallback support information indicates that emergency services fallback via fallback to CS service is supported and emergency services fallback via fallback to EPC service is not supported, the wireless device may perform fallback to CS service to attempt to obtain emergency services based at least in part on the emergency services fallback support information. Further, if the attempt to obtain emergency services via fallback to CS service is unsuccessful, the wireless device may next proceed to search for a different public land mobile network (PLMN) based at least in part on the emergency services fallback support information, e.g., instead of next attempting to obtain emergency services via fallback to EPC service with the same PLMN.

Numerous other scenarios in which the emergency services support information and/or emergency services fallback support information are used to help determine how to attempt to obtain emergency services are also possible. At least in some instances, this information may generally be used by the wireless device to determine to not attempt to obtain emergency services via an approach that is indicated to be unsupported by the cellular network, to proceed to attempt to obtain emergency services via an approach that is indicated to be supported by the cellular network, and/or possibly to move to another cellular network to attempt to obtain emergency services if there are no remaining approaches to obtaining emergency services indicated to be supported by the cellular network. This may accordingly help reduce delays to obtaining access to emergency services, in at least some scenarios.

In some instances, the wireless device may, additionally or alternatively, be configured to track the outcome(s) of attempts to obtain emergency services, e.g., on a per cell basis. For example, when an attempt to obtain emergency services is triggered while connected to a 5G cell, the wireless device could store information indicating in what manner emergency services are (e.g., eventually) successfully obtained, such as whether an emergency call succeeded via 5GS service on the 5G cell, via fallback to EPC service, via fallback to CS service, or by moving to a different PLMN (possibly including tracking with which PLMN emergency services are successfully obtained). Such information could additionally or alternatively include information indicating one or more mechanisms for obtaining emergency services that were unsuccessfully attempted. Such information could be stored locally by the wireless device (e.g., in non volatile memory), and/or be provided to a server (e.g., as server that is configured to assist wireless devices with efficiently obtaining emergency services), which could aggregate similar information received from other wireless device for various cells. Such aggregated information, and/or information generated based at least in part on such aggregated information, could in turn be provided to the wireless device (e.g., and other wireless devices), e.g., for use in determining how to attempt to obtain emergency services when such an attempt is triggered at the wireless device while connected to a cell for which information about the outcomes of previous attempts to obtain emergency service while connected to the cell is available. In some instances, such information may function as emergency services fallback support information for a cell, e.g., in case the cellular network does not provide any such information, or as a supplement to emergency services fallback support information for a cell, e.g., in addition to any emergency services fallback support information provided by the cellular network.

For example, based on such past “fingerprinting” information, for a 5G cell, the wireless device could select a procedure for attempting to obtain emergency services. As one possibility, this may include determining whether to attempt to obtain emergency services via 5GS on the 5G cell, via fallback to EPC service, via fallback to CS service, or via moving to a different PLMN (possibly including to which PLMN). As another possibility, selecting the procedure may include determining an order in which to prioritize performing various possible approaches to attempting to obtain emergency services, e.g., as needed. The selection could be based on which approach most commonly resulted in successfully obtaining emergency services in previous instances, according to the cell fingerprinting information, and/or based on any of various other possible considerations and/or cell fingerprinting information available to the wireless device, according to various embodiments.

As previously noted herein, in at least some instances, the wireless device may determine to perform fallback from 5GS service (e.g., to EPC service and/or CS service) in order to attempt to obtain emergency services. It should be noted that, at least according to some embodiments, in such instances, the wireless device may determine to disable an N1 interface for the wireless device, e.g., based at least in part on determining to perform fallback from 5GS service. This may help prevent the wireless device from re-selecting to 5GS service (e.g., with which the wireless device may have been unable to obtain emergency services) while connected to (and potentially for a period of time following being connected to) emergency services, at least in some instances. It may be the case that the wireless device enables the N1 interface for the wireless device after a certain period of time has elapsed after the emergency services session is released.

In some instances, emergency services fallback from 5GS service may be supported by an N26 interface, e.g., to facilitate redirection or handover to EPC service. However, in other instances, the N26 interface may not be supported. In such a scenario, it may be the case that the wireless device performs a combined attach procedure to obtain packet switched (PS) and CS service, e.g., based at least in part on performing emergency services fallback from 5GS while the N26 interface is not supported. This may help reduce the delay to accessing emergency services, for example if there is a need to further fallback to CS service after unsuccessfully attempting to obtain emergency services via PS (e.g., EPC) service.

In some instances, the wireless device may determine whether to perform emergency services fallback from 5GS service based at least in part on a 5G barring factor for emergency services access category for a serving cell of the wireless device. For example, if an attempt to obtain emergency services is triggered while connected to a cell that has a barring factor above a certain threshold (e.g., any non-0 barring factor, as one possibility) for emergency access, it may be the case that the wireless device determines to perform fallback from 5GS to attempt to obtain emergency services, e.g., based at least in part on the 5G barring factor for emergency access being above the specified threshold.

In some instances, the wireless device may determine whether to perform emergency services fallback from 5GS service based at least in part on a type of emergency service that is triggered. For example, in some instances, it may be preferable to fallback to EPC service for a text-to-911 (T911 ) session, e.g., since some 5GS networks may not allow or support location requests over NR. Accordingly, at least according to some embodiments, the wireless device may determine to perform fallback from 5GS to attempt to obtain emergency services based at least in part on user input initiating a text to 911 session while connected to a 5G NR cell.

Thus, the method of FIG. 7 may be used to support efficient access to emergency services by wireless devices. As described herein, such techniques may be particularly helpful when performing fallback from 5GS service to obtain emergency services may be necessary and/or more effective than attempting to obtain emergency services via 5GS service, among various possible scenarios.

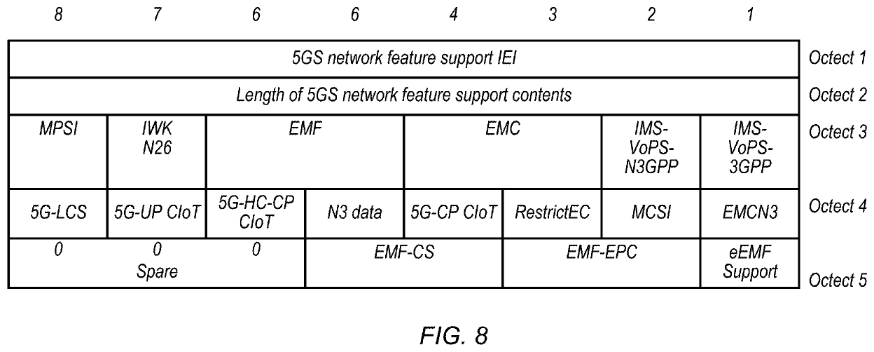

### FIGS. 8-14 and Additional Information

FIGS. 8-14 illustrate further aspects that might be used in conjunction with the method of FIG. 7 if desired. It should be noted, however, that the exemplary details illustrated in and described with respect to FIGS. 8-14 are not intended to be limiting to the disclosure as a whole: numerous variations and alternatives to the details provided herein below are possible and should be considered within the scope of the disclosure.

As part of the 5GS network feature support information element sent by the network in the registration accept message, it may be the case that there are multiple fields related to emergency calls, which may include an emergency service support indicator for 3GPP access (EMC) and an emergency service fallback indicator for 3GPP access (EMF). FIG. 8 illustrates various possible fields of such an IE, including EMF and EMC fields, according to some embodiments. At least as one possibility, the EMC field may include two bits, and may be defined such that the possible values of the field can indicate that emergency services are not supported, emergency services are supported in NR connected to 5G core network (5GCN) only, emergency services are supported in E-UTRA connected to 5GCN only, or emergency services are supported in NR connected to 5GCN and E-UTRA connected to 5GCN. It may be the case that the EMF field similarly includes two bits, and may be defined such that the possible values of the field can indicate that emergency services fallback is not supported, emergency services fallback is supported in NR connected to 5GCN only, emergency services fallback is supported in E-UTRA connected to 5GCN only, or emergency services fallback is supported in NR connected to 5GCN and E-UTRA connected to 5GCN.

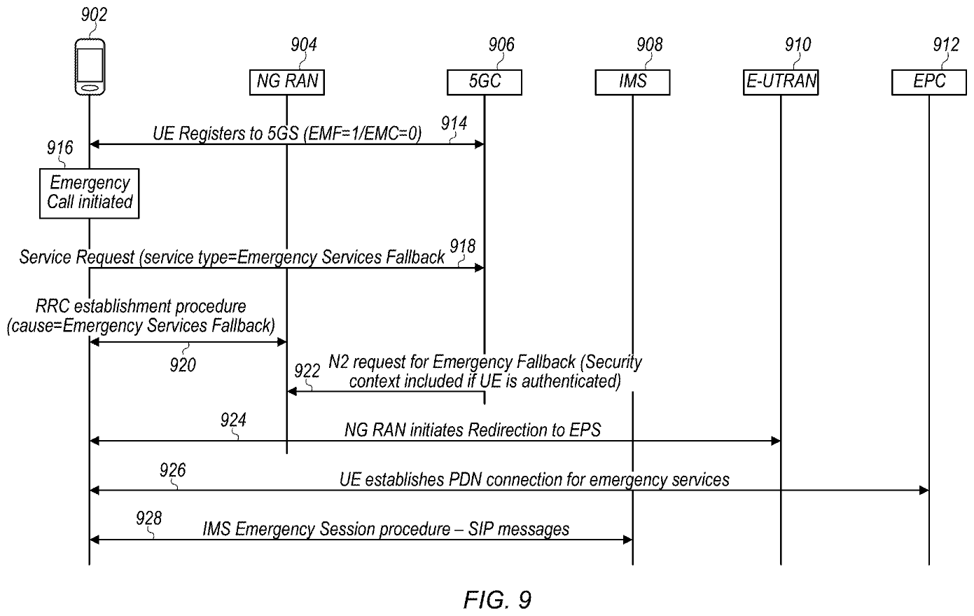

FIG. 9 is a call flow diagram illustrating how an emergency services fallback procedure might proceed in a scenario in which emergency services via 5GS service is not supported and emergency services fallback is supported. In 914, a UE 902 may register for 5GS service with a 5GC network 906 via a next generation radio access network (NG RAN) 904. In 916, an emergency call may be initiated at the UE 902. In 918, the UE 902 may provide a service request for emergency services fallback to the 5GC network. In 920, the UE 902 may perform a RRC establishment procedure, with cause=emergency services fallback, with the NG RAN 904. In 922, the 5GC network 906 may provide an N2 request for emergency fallback (including security context if the UE 902 is authenticated) to the NG RAN 904. In 924, the NG RAN 904 may initiate redirection or handover to evolved packet service (EPS) with an E-UTRA network (E-UTRAN) 910. In 926, the UE 902 may establish a packet data network (PDN) connection for emergency services with an evolved packet core (EPC) network 912. In 928, the UE 902 may perform an Internet Protocol Multimedia Subsystem (IMS) emergency session procedure, e.g., using Session Initiation Protocol (SIP) messages, with an IMS server 908, to establish the emergency call.

It may be the case that the EMF field is ambiguous, e.g., if defined as previously described herein. For example, even if such a field indicates that emergency services fallback is supported, the field may not explicitly specify if emergency services are supported via fallback to EPC on same PLMN, via fallback to CS on same PLMN, or both. This could allow for a double delay problem for emergency calls, at least in some instances. For instance, when a user dials an emergency call and emergency calling is supported via fallback to CS but not via fallback to EPC, a UE could perform fallback to LTE from 5GS service, including attempting registration on LTE, only to receive an indication from the network that IMS voice over packet switched (VoPS) service is not supported. The UE might then search for and camp on a RAT that provides CS service (e.g., a 3G or 2G RAT), and initiate the emergency call via the CS service. Alternatively, the UE might initiate Circuit Switched Fallback Procedure (CSFB) by sending an Extended Service Request (ESR) on LTE. Thus, in such a scenario, the UE may first fallback to LTE, then fallback a second time to CS service before actually establishing the emergency call.

As another example, in some roaming scenarios, it may be the case that the visited PLMN (VPLMN) offers emergency services for inbound roaming subscribers via CSFB, although it supports emergency services for its own subscribers via IMS. Some UEs may only support LTE and 5G service, such that these UEs would not be able to obtain emergency services via such a VPLMN, however, the network could indicate that emergency fallback services are supported to these UEs, since in this exemplary scenario it supports emergency services in the CS domain for roaming users. For UEs which may only support 5G and LTE (e.g., such as might be offered by some original equipment manufacturers (OEMs) in the market), this network behavior may mislead a UE to attempt an emergency services fallback to EPC procedure, which may lead to call failure, and causing the UE to search for another PLMN that supports emergency services over LTE and/or 5G before the emergency call can be established. Thus, in such a scenario, the UE may first fallback from 5G to LTE, attempt registration on LTE and receive an indication that emergency bearer over EPC is not supported, then attempt to find another PLMN that can service emergency calls on LTE and/or 5G.

It may be preferable to avoid such additional delays, as any amount of delay may have a significant impact in an emergency situation. Accordingly, it may be beneficial, at least in some instances, for the AMF to explicitly indicate (e.g., in the 5GS network feature support IE in the registration accept message) whether support for emergency services fallback is available via each of EPC and CS service on the same PLMN. Accordingly, as further illustrated in FIG. 8, the 5GS network feature support IE may include an extended EMF procedure supported field (“eEMFSupport”) (e.g., a Boolean field) to indicate whether the extended EMF feature is supported, at least according to some embodiments. If set to TRUE, it may be specified that a UE shall ignore the existing EMF field (e.g., and instead recognize the new EMF-EPC and EMF-CS fields). If set to FALSE, it may be specified that a UE should ignore the new EMF-EPC and EMF-CS fields (e.g., and instead recognize the legacy EMF field).

As one possibility, the new EMF-EPC field may be two bits and the possible values of the field may be defined as specifying one of: EMF-EPC not supported (e.g., value 00); EMF-EPC supported in NR connected to 5GC only (e.g., value 01); EMF-EPC supported in E-UTRA connected to 5GC only (e.g., value 10); or EMF-EPC supported in both NR and E-UTRA connected to 5GC (e.g., value 11). The new EMF-CS field may similarly be two bits and the possible values of the field may be defined as specifying one of: EMF-CS not supported (e.g., value 00); EMF-CS supported in NR connected to 5GC only (e.g., value 01); EMF-CS supported in E-UTRA connected to 5GC only (e.g., value 10); or EMF-CS supported in both NR and E-UTRA connected to 5GC (e.g., value 11). Variations on such a framework and/or various other frameworks for indicating whether emergency services fallback via each of EPC and CS services are also possible.

As an example, according to such a framework, when the registration accept message for a UE indicates eEMF Support=1, EMF-EPC=00, and EMF-CS=11, when a user dials an emergency call when the UE is on 5G, the UE may fallback directly to 3G or 2G service, and initiate a CS emergency call; if the call establishment fails, the UE may move to another PLMN. Thus, in such a scenario, the UE may be able to skip attempting to fallback to LTE to establish the emergency call, since the network has indicated to the UE that emergency services fallback via LTE is unavailable.

As another example, according to such a framework, when the registration accept message for a UE indicates eEMF Support=1, EMF-EPC=11, and EMF-CS=00, when a user dials an emergency call when the UE is on 5G, the UE may fallback to LTE service, and initiate an IMS based emergency call; if the call establishment fails, the UE may move to another PLMN. Thus, in such a scenario, the UE may be able to skip attempting to fallback to CS to establish the emergency call if the IMS based call establishment fails, since the network has indicated to the UE that emergency services fallback via CS is unavailable.

As still another example, according to such a framework, when the registration accept message for a UE indicates eEMF Support=1, EMF-EPC=11, and EMF-CS=11, when a user dials an emergency call when the UE is on 5G, the UE may fallback to LTE service, and initiate an IMS based emergency call; if the call establishment fails, the UE may then fallback to CS service on the same PLMN, and initiate a CS emergency call; if that call establishment fails, the UE may then move to another PLMN. Thus, in such a scenario, the UE may attempt all of the options indicated to be supported with the current PLMN before moving to another PLMN, since the network has indicated to the UE that emergency services fallback via both LTE and CS is available.

Note that other options for providing emergency services fallback support information are also possible. As one such possibility, in the registration accept message message, 1 extra bit may be provided as a EMF-CS field. The possible values of the field may be defined as specifying one of: no information is provided regarding emergency services fallback (e.g., value 0); or emergency services fallback to EPS will be followed by fallback to CS (e.g., value 1). By setting this bit to 1, a 3GPP Release 16 or later network may be able to indicate that for this subscriber, once the UE has performed emergency services fallback to EPS, the network will provide emergency services not via IMS, but only via subsequent fallback to CS. In such a scenario, a UE may be able to use this information, e.g., to perform an autonomous cell search procedure for CS service instead of following the network directed approach, which may reduce delay in obtaining emergency services. Note that if the bit is set to 0, this may be an indication that the network is a 3GPP Release 15 network that does not support this EMF-CS field/flag, and no indication is intended regarding whether emergency services will be provided via IMS or via subsequent fallback to CS, or may be an indication that the network is a 3GPP Release 16 or later network that intends to provide the emergency service via IMS.

In case the network does not support such more explicit emergency services fallback indications for emergency fallback via EPC service and via CS service, or possibly as a supplement even if such more explicit emergency services fallback indications are provided, it may be useful for UEs to perform “fingerprinting” of the past emergency call performance for 5G cells. For example, there may be cases where one or both of a UE or an AMF is configured according to a previous specification version and does not support the extended EMF fields. The fingerprinting for a cell may include storing information regarding the outcome of emergency call instances initiated on the cell. For example, information may be stored indicating whether an emergency call succeeded via 5G service, via fallback to LTE, via fallback to CS, or via a different PLMN (e.g., including storing information indicating on which PLMN the emergency call succeeded). Such information may be stored locally in the wireless device (e.g., in non-volatile memory), and additionally or alternatively may be provided to an entity (e.g., provided by a server computer, or group of servers, among various possibilities) configured to store and/or aggregate such cell fingerprinting information received from multiple UEs. That entity may in turn provide the aggregated cell fingerprinting information (and/or information generated based on such aggregated cell fingerprinting information) to UEs that may be able to use such information to inform their decisions of how to attempt to obtain emergency services in view of the past emergency call performance for their current cell. Thus, when a new emergency call is initiated by a user of a UE, based on the past cell fingerprinting information stored by the UE, the UE may decide whether to initiate the emergency call over 5G, via fallback to LTE, via fallback to CS, or via moving to a different PLMN, in such a way as to increase the likelihood of establishing the emergency call in the quickest possible manner.

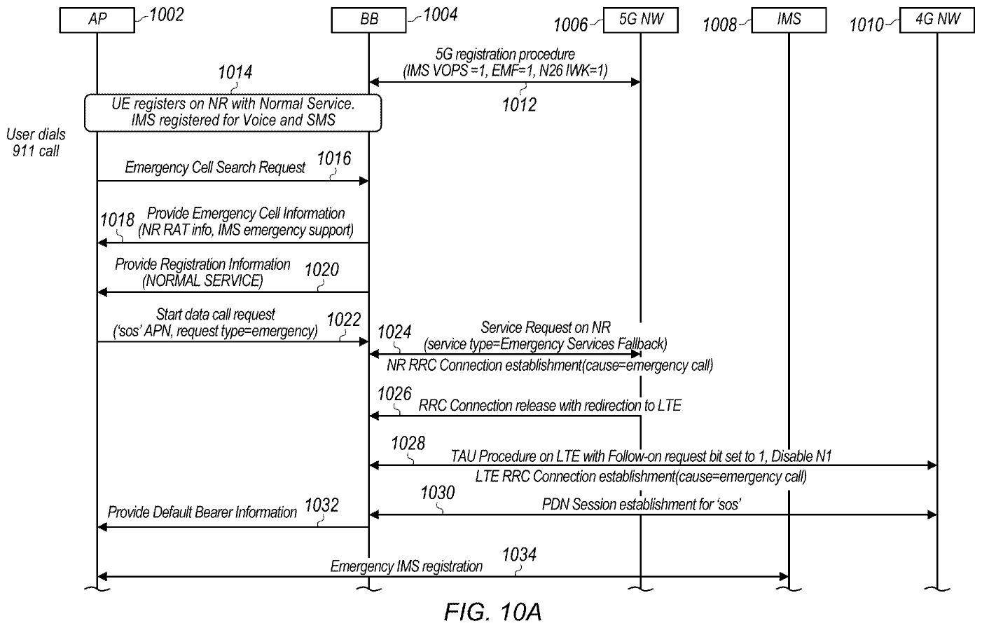

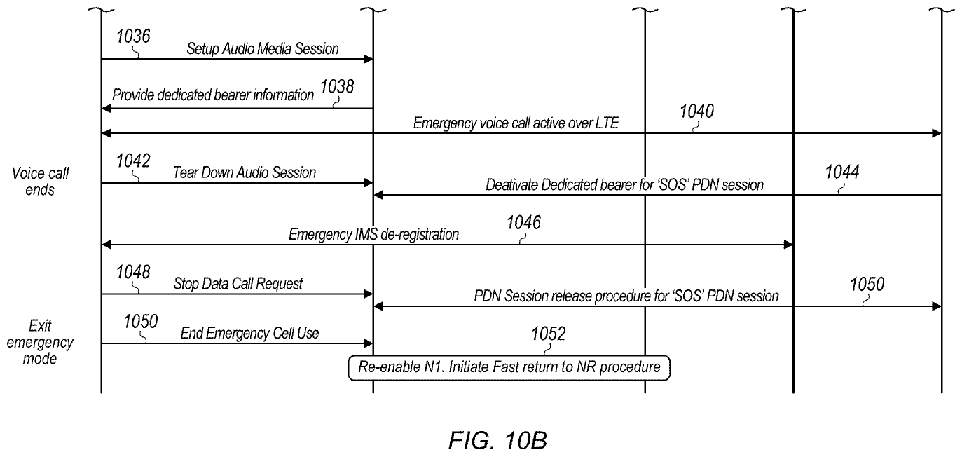

FIGS. 10A-10B are a call flow diagram illustrating how an emergency services fallback procedure might proceed in a scenario in which extended emergency services fallback information is available, in which emergency services via 5GS service is not supported, and in which emergency services fallback via EPC service is supported. The procedure may be performed between an application processor (AP) 1002 and a baseband processor (BB) 1004 of a UE, and a 5G network 1006, IMS 1008, and 4G network 1010.

As shown, in 1012, a 5G registration procedure may be performed between the BB 1004 and the 5G NW 1006. In 1014, the UE may register on NR with normal service, including IMS registration for voice and SMS services. In 1016, after a user of the UE dials a 911 call, the AP 1002 may provide an emergency cell search request to the BB 1004. In 1018, the BB 1004 may provide cell information for the emergency cell search request to the AP 1002 (e.g., indicating NR RAT information, and IMS emergency support information, for the serving cell of the UE), and in 1020, may provide registration information (e.g., indicating normal service). In 1022, the AP 1002 may request that the BB 1004 start a data call (e.g., with APN ‘sos’ and request type ‘emergency’ In 1024, BB 1004 may provide a service request on NR (e.g., with service type=emergency services fallback) and perform NR RRC connection establishment (e.g., with cause=emergency call) with the 5G NW 1006. In 1026, the 5G NW 1006 may provide a RRC connection release indication with redirection to LTE to the BB 1004. In 1028, the BB 1004 may perform a tracking area update (TAU) procedure and perform LTE RRC connection establishment (e.g., with cause=emergency call) with the 4G NW 1010, with a follow-on request bit set to 1, and may disable its N1 interface by setting the N1 mode field in the UE network capability information element to “N1 mode not supported”. As part of the TAU procedure, the BB 1004 may learn whether the 4G NW 1010 supports IMS voice capability. In 1030, the BB 1004 may perform PDN session establishment for ‘sos’ with the 4G NW 1010. In 1032, the BB 1004 may provide default bearer information for the PS session to the AP 1002. In 1034, the AP 1002 may perform emergency IMS registration with the IMS 1008. In 1036, the AP 1002 may set up an audio media session with the BB 1004. In 1038, the BB 1004 may provide dedicated bearer information to the AP 1002. In 1040, the emergency voice call may be active over LTE between the AP 1002 and the 4G NW 1010. In 1042, the voice call may end, and the AP 1002 may indicate to the BB 1004 to tear down the audio session. In 1044, the 4G NW 1010 may deactivate the dedicated bearer for the ‘sos’ PDN session. In 1046, the IMS 1008 may provide an emergency IMS de-registration indication to the AP 1002. In 1048, the AP 1002 may request that the BB 1004 stop the data call. In 1050, the BB 1004 and the 4G NW 1010 may perform a PDN session release procedure for the ‘sos’ PDN session. In 1050, the AP 1002 may exit emergency mode, and may indicate to the BB 1004 that the emergency cell use can end. In 1052, the BB 1004 may re-enable the N1 interface and may initiate a fast return to NR procedure.

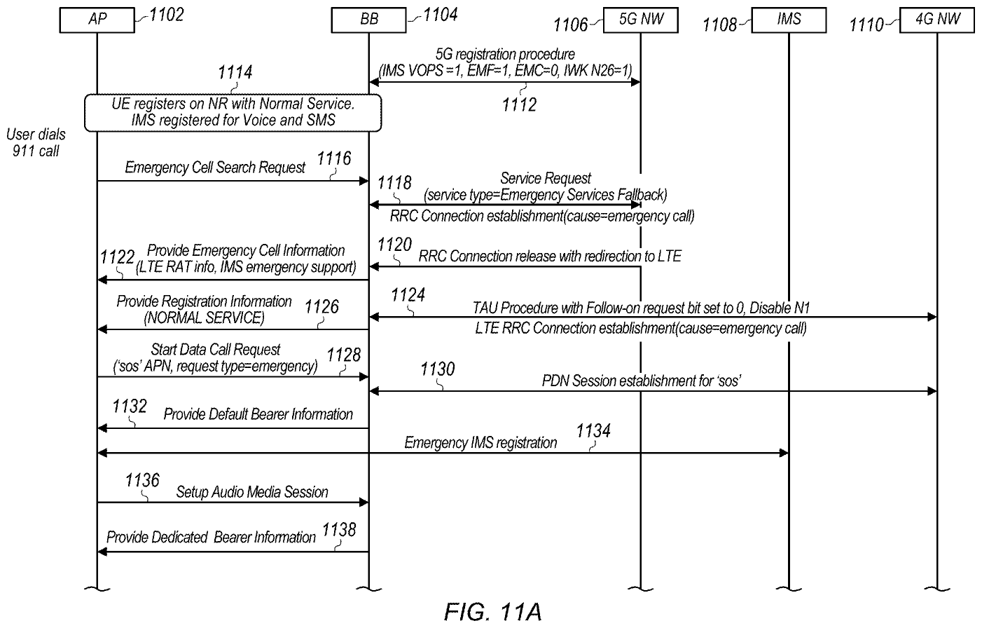

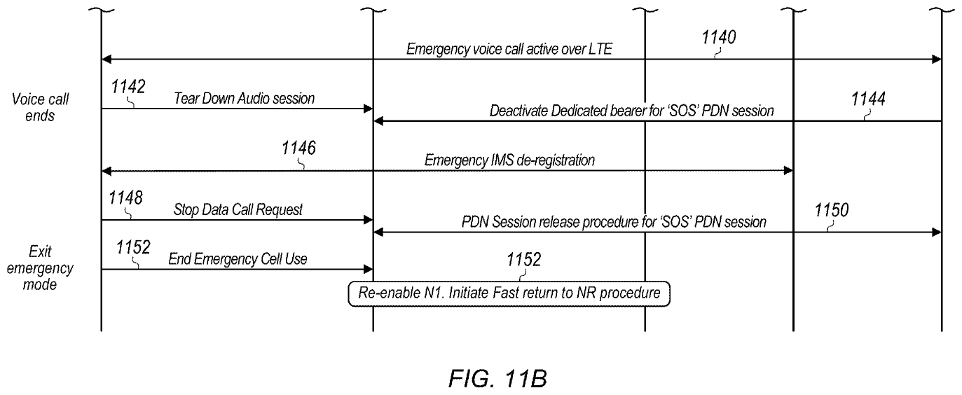

FIGS. 11A-11B are a call flow diagram illustrating an alternate approach to how an emergency services fallback procedure might proceed in a scenario in which extended emergency services fallback information is available, in which emergency services via 5GS service is not supported, and in which emergency services fallback via EPC service is supported. The procedure may be performed between an AP 1102 and a BB 1104 of a UE, and a 5G NW 1106, IMS 1108, and 4G NW 1110.

As shown, in 1112, a 5G registration procedure may be performed between the BB 1104 and the 5G NW 1106. In 1114, the UE may register on NR with normal service, including IMS registration for voice and SMS services. In 1116, after a user of the UE dials a 911 call, the AP 1102 may provide an emergency cell search request to the BB 1104. In 1118, BB 1104 may provide a service request on NR (e.g., with service type=emergency services fallback) and perform NR RRC connection establishment (e.g., with cause=emergency call) with the 5G NW 1106. In 1120, the 5G NW 1106 may provide a RRC connection release indication with redirection to LTE to the BB 1104. In 1122, the BB 1104 may provide cell information for the emergency cell search request to the AP 1102 (e.g., indicating LTE RAT information, and IMS emergency support information, for the serving cell of the UE). In 1124, the BB 1104 may perform a TAU procedure and perform LTE RRC connection establishment (e.g., with cause=emergency call) with the 4G NW 1110, with a follow-on request bit set to 0, and may disable its N1 interface by setting the N1 mode field in UE network capability information element to “N1 mode not supported”. As part of the TAU procedure, the BB 1104 may learn whether the 4G NW 1110 supports IMS voice capability. In 1126, the BB 1104 may provide registration information (e.g., indicating normal service) to the AP 1102. In 1128, the AP 1102 may request that the BB 1104 start a data call (e.g., with APN ‘sos’ and request type ‘emergency’. In 1130, the BB 1104 may perform PDN session establishment for ‘sos’ with the 4G NW 1110. In 1132, the BB 1104 may provide default bearer information for the PS session to the AP 1102. In 1134, the AP 1102 may perform emergency IMS registration with the IMS 1108. In 1136, the AP 1102 may set up an audio media session with the BB 1104. In 1138, the BB 1104 may provide dedicated bearer information to the AP 1102. In 1140, the emergency voice call may be active over LTE between the AP 1102 and the 4G NW 1110. In 1142, the voice call may end, and the AP 1102 may indicate to the BB 1104 to tear down the audio session. In 1144, the 4G NW 1110 may deactivate the dedicated bearer for the ‘sos’ PDN session. In 1146, the IMS 1108 may provide an emergency IMS de-registration indication to the AP 1102. In 1148, the AP 1102 may request that the BB 1104 stop the data call. In 1150, the BB 1104 and the 4G NW 1110 may perform a PDN session release procedure for the ‘sos’ PDN session. In 1150, the AP 1102 may exit emergency mode, and may indicate to the BB 1104 that the emergency cell use can end. In 1152, the BB 1104 may re-enable the N1 interface and may initiate a fast return to NR procedure.

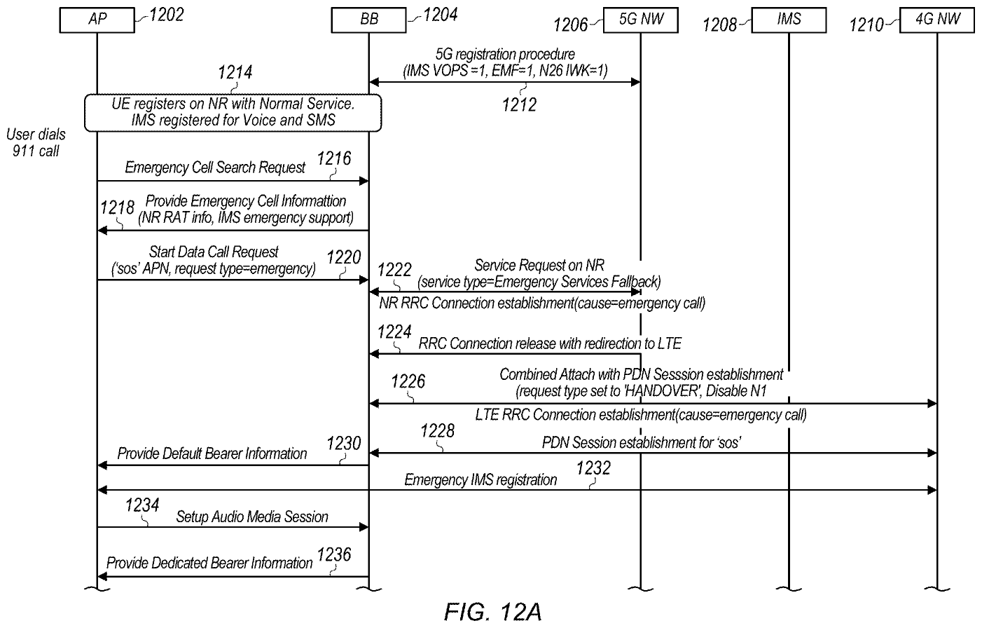

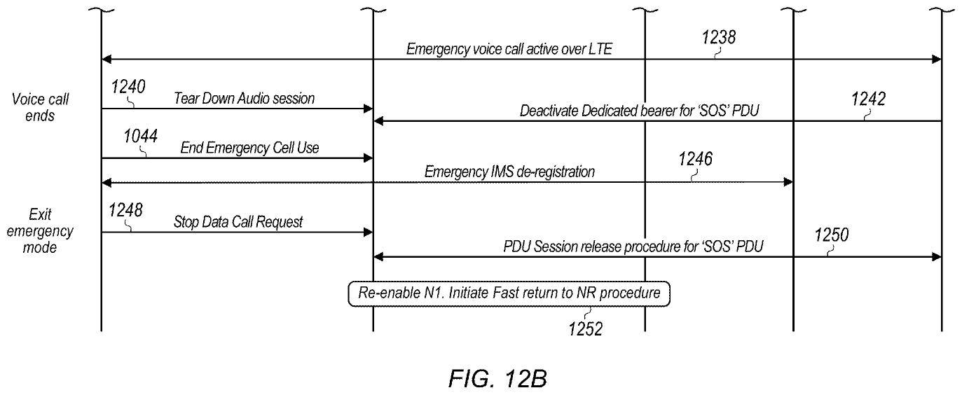

FIGS. 12A-12B are a call flow diagram illustrating an approach to how an emergency services fallback procedure might proceed in a scenario in which extended emergency services fallback information is available, in which emergency services via 5GS service is not supported, and in which emergency services fallback via EPC service is supported, where an N26 interface is not supported. The procedure may be performed between an AP 1202 and a BB 1204 of a UE, and a 5G NW 1206, IMS 1208, and 4G NW 1210.

As shown, in 1212, a 5G registration procedure may be performed between the BB 1204 and the 5G NW 1206. In 1214, the UE may register on NR with normal service, including IMS registration for voice and SMS services. In 1216, after a user of the UE dials a 911 call, the AP 1202 may provide an emergency cell search request to the BB 1204. In 1218, the BB 1204 may provide cell information for the emergency cell search request to the AP 1202 (e.g., indicating NR RAT information, and IMS emergency support information, for the serving cell of the UE). In 1220, the AP 1202 may request that the BB 1204 start a data call (e.g., with APN ‘sos’ and request type ‘emergency’ In 1222, BB 1204 may provide a service request on NR (e.g., with service type=emergency services fallback) and perform NR RRC connection establishment (e.g., with cause=emergency call) with the 5G NW 1206. In 1224, the 5G NW 1206 may provide a RRC connection release indication with redirection to LTE to the BB 1204. In 1226, the BB 1204 may perform a combined CS+PS attach procedure with PDN session establishment (with request type set to ‘handover’) and perform LTE RRC connection establishment (e.g., with cause=emergency call) with the 4G NW 1210, and may disable its N1 interface. In 1228, the BB 1204 may perform PDN session establishment for ‘sos’ with the 4G NW 1210. In 1230, the BB 1204 may provide default bearer information for the PS session to the AP 1202. In 1232, the AP 1202 may perform emergency IMS registration with the IMS 1208. In 1234, the AP 1202 may set up an audio media session with the BB 1204. In 1236, the BB 1204 may provide dedicated bearer information to the AP 1202. In 1238, the emergency voice call may be active over LTE between the AP 1202 and the 4G NW 1210. In 1240, the voice call may end, and the AP 1202 may indicate to the BB 1204 to tear down the audio session. In 1242, the 4G NW 1210 may deactivate the dedicated bearer for the ‘sos’ PDN session. In 1244, the AP 1202 may exit emergency mode, and may indicate to the BB 1204 that the emergency cell use can end. In 1246, the IMS 1208 may provide an emergency IMS de-registration indication to the AP 1202. In 1248, the AP 1202 may request that the BB 1204 stop the data call. In 1250, the BB 1204 and the 4G NW 1210 may perform a PDN session release procedure for the ‘sos’ PDN session. In 1252, the BB 1204 may re-enable the N1 interface and may initiate a fast return to NR procedure.

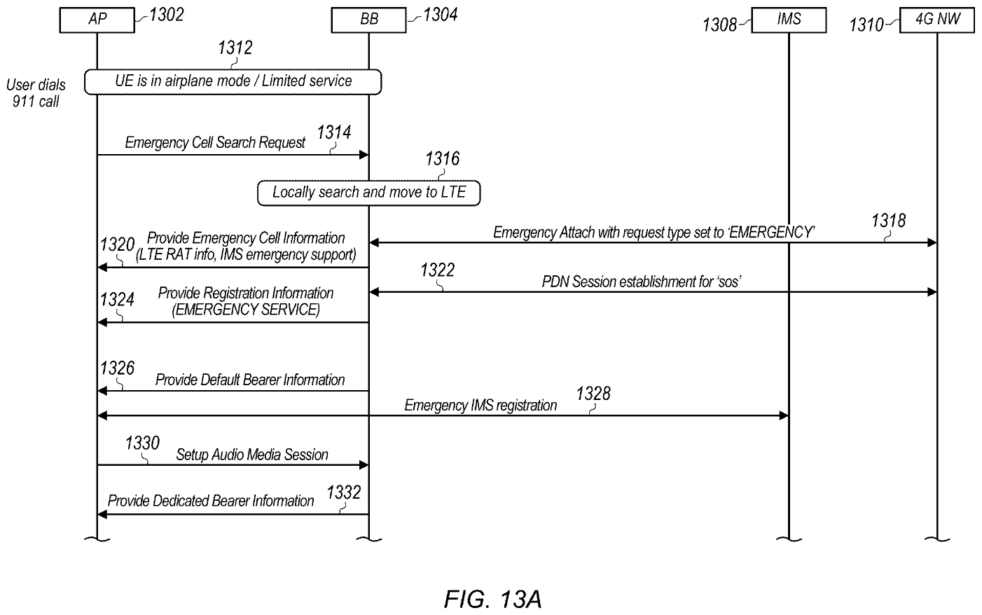

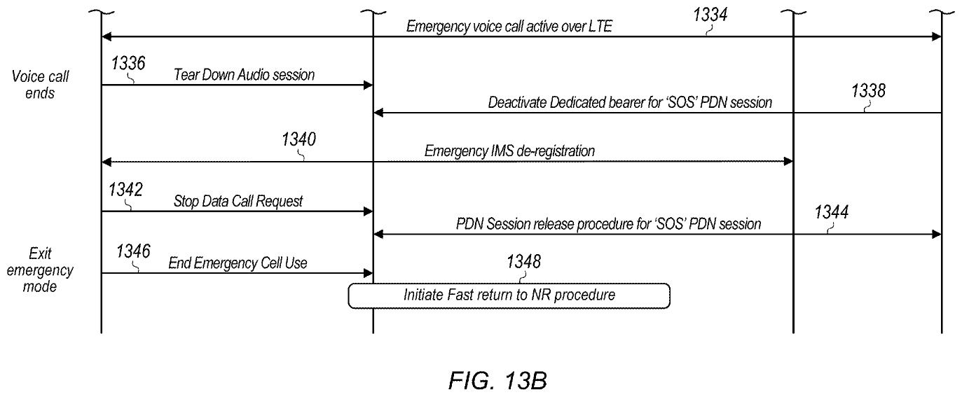

FIGS. 13A-13B are a call flow diagram illustrating an approach to how an emergency services fallback procedure might proceed in a scenario in which a UE is in airplane mode or otherwise has limited service. The procedure may be performed between an AP 1302 and a BB 1304 of a UE, an IMS 1308, and a 4G NW 1310.

As shown, in 1312, the UE may be in airplane mode or otherwise have limited service. In 1314, after a user of the UE dials a 911 call, the AP 1302 may provide an emergency cell search request to the BB 1304. In 1316, the BB 1304 may locally search for and move to LTE. In 1318, the BB 1304 may perform and emergency attach procedure with the 4G NW 1310, with request type set to ‘emergency’. In 1320, the BB 1304 may provide cell information for the emergency cell search request to the AP 1302 (e.g., indicating LTE RAT information, and IMS emergency support information). In 1322, the BB 1304 may perform PDN session establishment for ‘sos’ with the 4G NW 1310. In 1324, the BB 1304 may provide registration information (e.g., indicating emergency service) to the AP 1302. In 1326, the BB 1304 may provide default bearer information for the PS session to the AP 1302. In 1328, the AP 1302 may perform emergency IMS registration with the IMS 1308. In 1330, the AP 1302 may set up an audio media session with the BB 1304. In 1332, the BB 1304 may provide dedicated bearer information to the AP 1302. In 1334, the emergency voice call may be active over LTE between the AP 1302 and the 4G NW 1310. In 1336, the voice call may end, and the AP 1302 may indicate to the BB 1304 to tear down the audio session. In 1338, the 4G NW 1310 may deactivate the dedicated bearer for the ‘sos’ PDN session. In 1340, the IMS 1308 may provide an emergency IMS de-registration indication to the AP 1302. In 1342, the AP 1302 may request that the BB 1304 stop the data call. In 1344, the BB 1304 and the 4G NW 1310 may perform a PDN session release procedure for the ‘sos’ PDN session. In 1346, the AP 1302 may exit emergency mode, and may indicate to the BB 1304 that the emergency cell use can end. In 1348, the BB 1304 may initiate a fast return to NR procedure.

According to some embodiments, a UE may be configured to operate according to certain baseband behavior rules in conjunction with various emergency services related conditions. As one possibility, under any conditions when emergency services fallback is supported while on NR (whether emergency services over NR is supported or emergency services over NR is not supported), the UE may be configured to stay on NR, and as part of a service request for ‘sos’ PDU establishment, to indicate the service type “emergency services fallback”. As another possibility, if emergency services are not supported over NR and emergency services fallback is also not supported, the UE may be configured to disable the N1 interface, and move to LTE as soon as the 5G registration accept message is received. Alternatively, under such conditions, the UE may be configured to wait until an emergency cell search request is received to move to an LTE cell.

A further possible condition and configured UE behavior may relate to reception of an emergency cell search request at baseband from the application processor. In such a scenario, as one possibility, as long as EMF and IMS VOPS is supported, the baseband may be configured to respond with cell information for the 5G cell. As another possibility, the baseband may trigger a service request for EMF, as well as initiate a TAU procedure on LTE to verify whether the LTE network support IMS VOPS, before responding to the AP with cell information. Still further, upon reception of an indication to start a data call for establishing ‘sos’ PDN connectivity, as one possibility, the baseband may initiate a service request on NR with service type equal to EMF, and then once on LTE, initiate ‘sos’ PDN session establishment. As another possibility, the baseband may directly initiate ‘sos’ PDN session establishment on LTE.

In some instances, emergency services fallback may be performed with N26 supported; in such a scenario, it may be the case that the baseband performs a TAU procedure on LTE, with a follow-on request bit set to 1. In some instances, emergency services fallback may be performed with N26 not supported; in such a scenario, it may be the case that the baseband performs a combined attach procedure on LTE, with a follow-on request bit set to 1. When performing system selection when in emergency mode, when in emergency mode on LTE (due to fallback), it may be the case that the UE is configured to disable NR by setting the N1 mode bit to 0 in the UE network capability information element, until the UE is no longer in emergency mode. For example, NR may be disabled as part of the TAU/Attach procedure initiated after fallback to LTE. It may be the case that a UE waits until exit from emergency mode to re-enable NR and initiate fast return to NR.

In some instances, it may be the case that access category 2 (emergency) is barred, or at least has a barring factor greater than 0, on NR. In such a scenario, it may be the case that the BB is configured to autonomously move to LTE based on an emergency cell search request from the AP, and to perform a TAU procedure on LTE. Additionally, in some instances, when a T911 session is initiated when on a 5G NR cell, it may be the case that the BB is configured to fallback to LTE once the T911 session starts, e.g., since some 5G networks may not allow or support location request over NR. In some instances, if an NR cell SIB1 does not indicate that emergency services over IMS support is provided, if in limited service, the BB may be configured not to camp on the NR cell.

In some instances, if a UE was in normal service on NR before an emergency call, it may be the case that the baseband tries to maintain normal service during the emergency call fallback to LTE, and during the configured callback period. In some instances, NR registration may be ongoing when an emergency cell search request is received from the AP by the BB, for example, if the UE has just moved to the NR cell via re-selection. In such a scenario, it may be the case that the UE is configured to abort the registration on NR, and to autonomously move to LTE for the emergency call fallback.

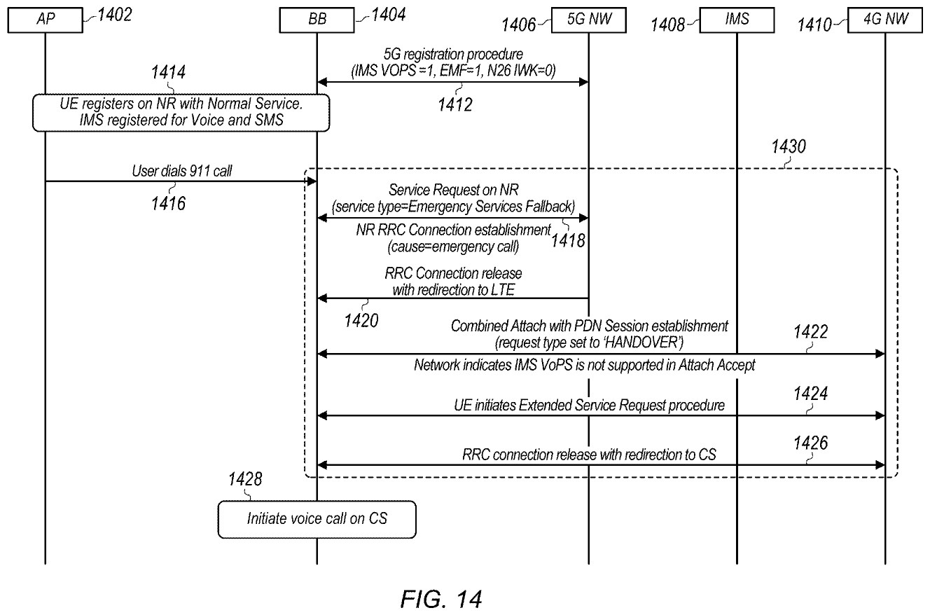

A UE that receives network information indicating emergency services fallback support provided by the network, and/or that is able to determine emergency services fallback support provided by the network based on cell fingerprinting information gathered from the wireless device and/or other wireless devices by way of an information aggregating entity, and uses such information to determine how to proceed when attempting to obtain emergency service access, may be able to substantially reduce the amount of time to obtain emergency service access, at least in some instances. FIG. 14 is a communication flow diagram illustrating possible differences between accessing emergency services via fallback to circuit switched service with and without provision of emergency services fallback support information, according to some embodiments.

As shown, in a scenario in which limited or no emergency services fallback support information is available to a wireless device, in 1412 the wireless device baseband 1404 may perform a 5G registration procedure (with configuration information indicating IMS VOPS=1, EMF=1, N26 IWK=0) with a 5G NW 1406. In 1414, the UE AP 1402 and BB 1404 may be registered on NR with normal service, and registered for voice and SMS with IMS 1408. In 1416, a user of the UE may dial a 911 call. In 1418, BB 1404 may perform a service request (service type=emergency services fallback) with the 5G NW 1406, e.g., including performing NR RRC connection establishment (cause=emergency call). In 1420, the 5G NW 1406 may provide a RRC connection release message with redirection to LTE. In 1422, the BB 1404 may perform a combined attach with PDN session establishment (request type set to ‘HANDOVER’) with a 4G NW 1410. The 4G NW 1410 may indicate that IMS VoPS is not supported in an attach accept message provided to the UE. In 1424, the BB 1404 may initiate an extended service request procedure with the 4G NW 1410. In 1426, the 4G NW 1410 may provide a RRC connection release message with redirection to CS. In 1428, the BB 1404 may initiate a voice call on CS.

If emergency services fallback support information indicating that emergency services fallback via EPC service is not supported by the 5G NW 1406 were provided, such as in accordance with techniques described herein, it may be possible for the UE to proceed directly from the user dialing the 911 call (1416) to initiating the voice call on CS (1428), e.g., potentially skipping some or all of the set of messages 1430. This may reduce the time to initiate the voice call on CS significantly for such a scenario. For example, in some instances, time savings of 2.5-3 s in an excellent coverage scenario, or time savings of 6-10 s in a poor coverage scenario, may be possible. Note that such time savings values are provided as examples only, and other values and/or ranges of values are also possible.

In the following further exemplary embodiments are provided.

One set of embodiments may include a cellular network element, comprising: a network port; and a processor coupled to the network port; wherein the cellular network element is configured to: provide emergency services fallback support information to a wireless device during third generation partnership project (3GPP) fifth generation system (5GS) cellular registration or during a UE configuration update procedure, wherein the emergency services fallback support information includes an indication of whether emergency services fallback via fallback to evolved packet core (EPC) service is supported, wherein the emergency services fallback support information includes an indication of whether emergency services fallback via fallback to circuit switched (CS) service is supported.

According to some embodiments, the emergency services fallback support information further includes an indication that the emergency services fallback support information includes an indication of whether emergency services fallback via fallback to EPC service is supported and an indication of whether emergency services fallback via fallback to CS service is supported.

According to some embodiments, the emergency services fallback support information is provided in a 5GS network features support information element, wherein the indication of whether emergency services fallback via fallback to EPC service is supported is included in a different field of the 5GS network features support information element than the indication of whether emergency services fallback via fallback to CS service is supported.

According to some embodiments, the indication of whether emergency services fallback via fallback to EPC service is supported further comprises an indication that one of: emergency services fallback via fallback to EPC service is not supported; emergency services fallback via fallback to EPC service is supported while connected to 5GS via a new radio (NR) air interface but not while connected to 5GS via an evolved universal terrestrial radio access (E-UTRA) air interface; emergency services fallback via fallback to EPC service is supported while connected to 5GS via an E-UTRA air interface but not while connected to 5GS via a NR air interface; or emergency services fallback via fallback to EPC service is supported while connected to 5GS via a NR air interface or an E-UTRA air interface.

According to some embodiments, the indication of whether emergency services fallback via fallback to CS service is supported further comprises an indication that one of: emergency services fallback via fallback to CS service is not supported; emergency services fallback via fallback to CS service is supported while connected to 5GS via a new radio (NR) air interface but not while connected to 5GS via an evolved universal terrestrial radio access (E-UTRA) air interface; emergency services fallback via fallback to CS service is supported while connected to 5GS via an E-UTRA air interface but not while connected to 5GS via a NR air interface; or emergency services fallback via fallback to CS service is supported while connected to 5GS via a NR air interface or an E-UTRA air interface.

Another set of embodiments may include a wireless device, comprising: an antenna; a radio operably coupled to the antenna; and a processor operably coupled to the radio; wherein the wireless device is configured to: receive emergency services fallback support information from a cellular network element during third generation partnership project (3GPP) fifth generation system (5GS) cellular registration or during a UE configuration update procedure, wherein the emergency services fallback support information includes an indication of whether emergency services fallback via fallback to evolved packet core (EPC) service is supported, wherein the emergency services fallback support information includes an indication of whether emergency services fallback via fallback to circuit switched (CS) service is supported.

According to some embodiments, the emergency services fallback support information further includes an indication that the emergency services fallback support information includes an indication of whether emergency services fallback via fallback to EPC service is supported and an indication of whether emergency services fallback via fallback to CS service is supported, wherein the processor is further configured to cause the wireless device to: ignore and not execute a handler for a legacy emergency service fallback indication based at least in part on wherein the indication that the emergency services fallback support information includes the indication of whether presence of either the emergency service fallback via fallback to EPC service is supported and the indication of whether or emergency service fallback via fallback to CS service is supported.

According to some embodiments, the emergency services fallback support information is provided in a 5GS network features support information element, wherein the indication of whether emergency services fallback via fallback to EPC service is supported is included in a different field of the 5GS network features support information element than the indication of whether emergency services fallback via fallback to CS service is supported.

According to some embodiments, the indication of whether emergency services fallback via fallback to EPC service is supported further comprises an indication of whether: emergency services fallback via fallback to EPC service is not supported; emergency services fallback via fallback to EPC service is supported while connected to 5GS via a new radio (NR) air interface but not while connected to 5GS via an evolved universal terrestrial radio access (E-UTRA) air interface; emergency services fallback via fallback to EPC service is supported while connected to 5GS via an E-UTRA air interface but not while connected to 5GS via a NR air interface; or emergency services fallback via fallback to EPC service is supported while connected to 5GS via a NR air interface or an E-UTRA air interface.

According to some embodiments, the indication of whether emergency services fallback via fallback to CS service is supported further comprises an indication of whether: emergency services fallback via fallback to CS service is not supported; emergency services fallback via fallback to CS service is supported while connected to 5GS via a new radio (NR) air interface but not while connected to 5GS via an evolved universal terrestrial radio access (E-UTRA) air interface; emergency services fallback via fallback to CS service is supported while connected to 5GS via an E-UTRA air interface but not while connected to 5GS via a NR air interface; or emergency services fallback via fallback to CS service is supported while connected to 5GS via a NR air interface or an E-UTRA air interface.

Yet another set of embodiments may include an apparatus, comprising: a processor configured to cause a wireless device to: receive emergency services fallback support information from a cellular network element during third generation partnership project (3GPP) fifth generation system (5GS) cellular registration, wherein the emergency services fallback support information includes an indication of whether the emergency services fallback support information specifies whether emergency services fallback via fallback to evolved packet core (EPC) service is supported and whether emergency services fallback via fallback to circuit switched (CS) service is supported.

According to some embodiments, if the emergency services fallback support information indicates that the emergency services fallback support information specifies whether emergency services fallback via fallback to EPC service is supported and whether emergency services fallback via fallback to CS service is supported, the emergency services fallback support information further includes: an indication of whether emergency services fallback via fallback to EPC service is supported; and an indication of whether emergency services fallback via fallback to CS service is supported.

According to some embodiments, if the emergency services fallback support information indicates that emergency services fallback via fallback to EPC service is supported and emergency services fallback via fallback to CS service is not supported and the wireless device supports LTE, the processor is further configured to cause the wireless device to: receive user input initiating an attempt to obtain emergency services; perform fallback to EPC service to attempt to obtain emergency services based at least in part on the emergency services fallback support information; search for a different public land mobile network (PLMN) if the attempt to obtain emergency services via fallback to EPC service is unsuccessful based at least in part on the emergency services fallback support information.

According to some embodiments, if the emergency services fallback support information indicates that emergency services fallback via fallback to EPC service is not supported and emergency services fallback via fallback to CS service is supported and the wireless device supports one or more of a 2G or 3G RAT, the processor is further configured to cause the wireless device to: receive user input initiating an attempt to obtain emergency services; perform fallback to CS service to attempt to obtain emergency services based at least in part on the emergency services fallback support information; search for a different public land mobile network (PLMN) if the attempt to obtain emergency services via fallback to CS service is unsuccessful based at least in part on the emergency services fallback support information.

According to some embodiments, if emergency services support information indicates that emergency services via 5GS service are not supported and if the emergency services fallback support information indicates that emergency services fallback is not supported, the processor is further configured to cause the wireless device to: disable an N1 interface for the wireless device based at least in part on the indication that emergency services via 5GS service are not supported and the indication that emergency services fallback is not supported; and search for EPC service based at least in part on the indication that emergency services via 5GS service are not supported and the indication that emergency services fallback is not supported.

According to some embodiments, the processor is further configured to cause the wireless device to: attempt to obtain emergency services while connected to a first cell; store information indicating an outcome of the attempt to obtain emergency services while connected to the first cell in local non-volatile memory; and provide the information indicating an outcome of the attempt to obtain emergency services while connected to the first cell to a server.

According to some embodiments, the processor is further configured to cause the wireless device to: receive emergency services performance information for a first cell from a server or from a local memory of the wireless device; receive user input initiating an attempt to obtain emergency services while connected to the first cell; and select a procedure for attempting to obtain emergency services based at least in part on the emergency services performance information for the first cell.

According to some embodiments, the processor is further configured to cause the wireless device to: receive user input initiating an attempt to obtain emergency services; determine to perform fallback from 5GS to attempt to obtain emergency services; and disable an N1 interface for the wireless device based at least in part on determining to perform fallback from 5GS to attempt to obtain emergency services.

According to some embodiments, to disable the N1 interface for the wireless device, the processor is further configured to cause the wireless device to either: locally disable the N1 interface for the wireless device by disabling NR RAT; or indicate to the cellular network element to disable the N1 interface by setting a N1 mode field value to “N1 mode not supported” in a UE network capability information element.

According to some embodiments, the processor is further configured to cause the wireless device to: determine that the wireless device has exited an emergency mode; and re-enable the N1 interface for the wireless device based at least in part on determining that the wireless device has exited the emergency mode

According to some embodiments, the processor is further configured to cause the wireless device to: receive user input initiating an attempt to obtain emergency services; determine to perform fallback from 5GS to attempt to obtain emergency services while an N26 interface is not supported; and perform a combined attach procedure to obtain packet switched (PS) and circuit switched (CS) service based at least in part on performing emergency services fallback from 5GS while the N26 interface is not supported.

According to some embodiments, the processor is further configured to cause the wireless device to: receive user input initiating an attempt to obtain emergency services while connected to a first cell; determine a 5G access barring factor for emergency access category for the first cell; and determine whether to perform fallback from 5GS to attempt to obtain emergency services based at least in part on the 5G access barring factor for emergency access category for the first cell.

According to some embodiments, the processor is further configured to cause the wireless device to: receive user input initiating a text to 911 session while connected to a 5G NR cell; and determine to perform fallback from 5GS to attempt to obtain emergency services based at least in part on the user input initiating a text to 911 session while connected to a 5G NR cell.

According to some embodiments, the processor is further configured to cause the wireless device to: determine that the wireless device has limited service; determine whether a 5G NR cell indicates that emergency services over IMS support is provided; and determine whether to camp on the 5G NR cell while the wireless device has limited service based at least in part on whether the 5G NR cell indicates that emergency services over IMS support is provided.

Yet another exemplary embodiment may include a method, comprising: by a device: performing any or all parts of the preceding examples.

A yet further exemplary embodiment may include a non-transitory computer accessible memory medium comprising program instructions which, when executed at a device, cause the device to implement any or all parts of any of the preceding examples.

A still further exemplary embodiment may include a computer program comprising instructions for performing any or all parts of any of the preceding examples.

Yet another exemplary embodiment may include an apparatus comprising means for performing any or all of the elements of any of the preceding examples.

Still another exemplary embodiment may include an apparatus comprising a processor configured to cause a device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106, a BS 102, a network element 600) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A cellular network element, comprising:
a network port; and
a processor coupled to the network port;
wherein the cellular network element is configured to:
provide emergency services fallback support information to a wireless device during third generation partnership project (3GPP) fifth generation system (5GS) cellular registration or during a UE configuration update procedure,
wherein the emergency services fallback support information includes an indication of whether the emergency services fallback support information specifies one or more of whether emergency services fallback via fallback to evolved packet core (EPC) service is supported or whether emergency services fallback via fallback to circuit switched (CS) service is supported.

2. The cellular network element of claim 1,
wherein the emergency services fallback support information includes an indication of whether emergency services fallback via fallback to evolved packet core (EPC) service is supported,
wherein the emergency services fallback support information includes an indication of whether emergency services fallback via fallback to circuit switched (CS) service is supported.

3. The cellular network element of claim 2,
wherein the emergency services fallback support information is provided in a 5GS network features support information element,
wherein the indication of whether emergency services fallback via fallback to EPC service is supported is included in a different field of the 5GS network features support information element than the indication of whether emergency services fallback via fallback to CS service is supported.

4. The cellular network element of claim 2, wherein the indication of whether emergency services fallback via fallback to EPC service is supported further comprises an indication that one of:
emergency services fallback via fallback to EPC service is not supported;
emergency services fallback via fallback to EPC service is supported while connected to 5GS via a new radio (NR) air interface but not while connected to 5GS via an evolved universal terrestrial radio access (E-UTRA) air interface;
emergency services fallback via fallback to EPC service is supported while connected to 5GS via an E-UTRA air interface but not while connected to 5GS via a NR air interface; or
emergency services fallback via fallback to EPC service is supported while connected to 5GS via a NR air interface or an E-UTRA air interface.

5. The cellular network element of claim 2, wherein the indication of whether emergency services fallback via fallback to CS service is supported further comprises an indication that one of:
emergency services fallback via fallback to CS service is not supported;
emergency services fallback via fallback to CS service is supported while connected to 5GS via a new radio (NR) air interface but not while connected to 5GS via an evolved universal terrestrial radio access (E-UTRA) air interface;
emergency services fallback via fallback to CS service is supported while connected to 5GS via an E-UTRA air interface but not while connected to 5GS via a NR air interface; or
emergency services fallback via fallback to CS service is supported while connected to 5GS via a NR air interface or an E-UTRA air interface.

6. The cellular network element of claim 1, wherein the emergency services fallback support information includes an indication that one of:
no information is provided regarding emergency services fallback support; or
emergency services fallback support includes fallback to EPS service followed by fallback to CS service.

7. A wireless device, comprising:
an antenna;
a radio operably coupled to the antenna; and
a processor operably coupled to the radio;
wherein the wireless device is configured to:
receive emergency services fallback support information from a cellular network element during third generation partnership project (3GPP) fifth generation system (5GS) cellular registration or during a UE configuration update procedure,
wherein the emergency services fallback support information includes an indication of whether the emergency services fallback support information specifies one or more of whether emergency services fallback via fallback to evolved packet core (EPC) service is supported or whether emergency services fallback via fallback to circuit switched (CS) service is supported.

8. The wireless device of claim 7,
wherein the emergency services fallback support information indicates that the emergency services fallback support information specifies whether emergency services fallback via fallback to EPC service is supported and whether emergency services fallback via fallback to CS service is supported, wherein the processor is further configured to cause the wireless device to:
ignore and not execute a handler for a legacy emergency service fallback indication based at least in part on the indication that the emergency services fallback support information specifies whether emergency service fallback via fallback to EPC service is supported and whether emergency service fallback via fallback to CS service is supported.

9. The wireless device of claim 7,
wherein the emergency services fallback support information includes an indication of whether emergency services fallback via fallback to EPC service is supported,
wherein the emergency services fallback support information includes an indication of whether emergency services fallback via fallback to CS service is supported,
wherein the emergency services fallback support information is provided in a 5GS network features support information element,
wherein the indication of whether emergency services fallback via fallback to EPC service is supported is included in a different field of the 5GS network features support information element than the indication of whether emergency services fallback via fallback to CS service is supported.

10. The wireless device of claim 7,
wherein the emergency services fallback support information includes an indication that one of:
no information is provided regarding emergency services fallback support; or
emergency services fallback support includes fallback to EPS service followed by fallback to CS service.

11. An apparatus, comprising:
a processor configured to cause a wireless device to:
determine emergency services fallback support information for a first cell, wherein the first cell operates according to third generation partnership project (3GPP) fifth generation new radio (5G NR); and
select a procedure for attempting to obtain emergency services based at least in part on the emergency services fallback support information for the first cell.

12. The apparatus of claim 11,
wherein the emergency services fallback support information is received from a cellular network element during 3GPP fifth generation system (5GS) cellular registration,
wherein the emergency services fallback support information includes an indication of whether the emergency services fallback support information specifies whether emergency services fallback via fallback to evolved packet core (EPC) service is supported and whether emergency services fallback via fallback to circuit switched (CS) service is supported.

13. The apparatus of claim 11, wherein the processor is further configured to cause the wireless device to:
determine whether emergency services via fifth generation system (5GS) service are supported and whether emergency services fallback is supported based at least in part on the emergency services fallback support information;
disable an N1 interface for the wireless device if emergency services via 5GS service are not supported and emergency services fallback is not supported; and
search for evolved packet core (EPC) service based at least in part on emergency services via 5GS service not being supported and emergency services fallback not being supported.

14. The apparatus of claim 11, wherein the processor is further configured to cause the wireless device to:
attempt to obtain emergency services while connected to the first cell;
store information indicating an outcome of the attempt to obtain emergency services while connected to the first cell in local non-volatile memory; and
provide the information indicating an outcome of the attempt to obtain emergency services while connected to the first cell to a server.

15. The apparatus of claim 11, wherein the processor is further configured to cause the wireless device to:
receive emergency services performance information for the first cell from a server, or from a local memory of the wireless device, wherein the emergency services fallback support information for the first cell is determined based at least in part on the emergency services performance information for the first cell.

16. The apparatus of claim 11, wherein the processor is further configured to cause the wireless device to:
receive user input initiating an attempt to obtain emergency services;
determine to perform fallback from fifth generation system (5GS) to attempt to obtain emergency services;
disable an N1 interface for the wireless device based at least in part on determining to perform fallback from 5GS to attempt to obtain emergency services, wherein to disable the N1 interface for the wireless device, the processor is further configured to cause the wireless device to either:
locally disable the N1 interface for the wireless device by disabling NR RAT; or
indicate to the cellular network element to disable the N1 interface by setting a N1 mode field value to “N1 mode not supported” in a UE network capability information element.
determine, at a later time, that the wireless device has exited an emergency mode; and
re-enable, at the later time, the N1 interface for the wireless device based at least in part on determining that the wireless device has exited the emergency mode.

17. The apparatus of claim 11, wherein the processor is further configured to cause the wireless device to:
receive user input initiating an attempt to obtain emergency services;
determine to perform fallback from fifth generation system (5GS) to attempt to obtain emergency services while an N26 interface is not supported; and
perform a combined attach procedure to obtain packet switched (PS) and circuit switched (CS) service based at least in part on performing emergency services fallback from 5GS while the N26 interface is not supported.

18. The apparatus of claim 11, wherein the processor is further configured to cause the wireless device to:
receive user input initiating an attempt to obtain emergency services while connected to a first cell;
determine a fifth generation (5G) access barring factor for emergency access category for the first cell; and
determine whether to perform fallback from fifth generation system (5GS) to attempt to obtain emergency services based at least in part on the 5G access barring factor for emergency access category for the first cell.

19. The apparatus of claim 11, wherein the processor is further configured to cause the wireless device to:
receive user input initiating a text to 911 session while connected to a 5G NR cell; and
determine to perform fallback from fifth generation system (5GS) to attempt to obtain emergency services based at least in part on the user input initiating a text to 911 session while connected to a 5G NR cell.

20. The apparatus of claim 11, wherein the processor is further configured to cause the wireless device to:
determine that the wireless device has limited service;
determine whether a 5G NR cell indicates that emergency services over IMS support is provided; and
determine whether to camp on the 5G NR cell while the wireless device has limited service based at least in part on whether the 5G NR cell indicates that emergency services over IMS support is provided.
